(19) United States
(12) Patent Application Publication
(10) Pub. No.: US 2005/0129059 A1
(43) Pub. Date: Jun. 16, 2005

(54) Method of implementing PSEUDO wire emulation edge-to-edge protocol

(76) Inventors: Zhangzhen Jiang, Shenzhen (CN); Jianfei He, Shenzhen (CN); Jianyun Zhu, Shenzhen (CN)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/996,064

(22) Filed: Nov. 24, 2004

(30) Foreign Application Priority Data
Dec. 3, 2003 (CN) 2003101200670

(51) Int. Cl. H04J 3/24; H04J 3/16; G01R 31/08; G08C 15/00; H04J 3/22

(52) U.S. Cl. 370/466; 370/474

(57) ABSTRACT

The present invention relates to PWE3-based communication and discloses a method of implementing PWE3 protocol, with the aim to implement PWE3 architecture over RPR-based MPLS PSN, provide protection and bandwidth sharing capability, and improve quality and efficiency of PWE3 architecture. Said method of implementing PWE3 protocol comprises the following steps: A. Encapsulate data frame on said PWE3 PSN layer into RPR data frame; B. Transmit said RPR data frame to the destination node through RPR; C. Decapsulate said RPR data frame into PSN layer data frame at said destination node.

### FIELD OF THE INVENTION

The present invention relates to PWE3-based communication, particularly to a method of implementing PWE3 architecture on MPLS network.

### BACKGROUND OF THE INVENTION

MPLS is a standard protocol of IETF (Internet Engineering Task Force). MPLS is a label-based IP (Internet Protocol) routing method and pertains to the scope of L3 switching technology; it employs a label-based mechanism to separate routing from forwarding; the network path of any packet is determined by the label, and data is transmitted through the LSP (Label Switch Path); MPLS converts L3 packet switching into L2 switching in an IP network.

FIG.1 shows the network structure of MPLS. A MPLS network 101 comprises LSRs (Label Switch Routers) 104 in core part and LERs (Label Edge Routers) 103 in edge part. LER 103 is designed to analyze IP packet headers, execute L3 network functions, and decide corresponding transport levels and LSPs; it is connected to the external network 102 from which to receive external data packets 105; LSR 104 is designed to establish LSPs, execute label switch mechanism and QoS (Quality of Service), and forward data packets 106 in the MPLS network; it comprises a control unit and a switching unit, resides in the network, and is connected to LER 103 and other LSRs 104.

The label switching workflow of MPLS is as follows: first, establish a routing list and a label mapping list in LSR through LDP (Label Distribution Protocol) and conventional routing protocols such as OSPF (Open Shortest Path First); during network operation, the LER at entry to MPLS core network receives an IP packet from the external network, accomplishes L3 network functions, and adds a label to the IP packet; next, the data packet is transmitted in LSP, the LSR doesn't perform L3 processing for the packet; instead, it only forwards the packet via the switching unit according to the label; the data packet is transmitted to the other end (i.e., outlet) of the network finally; the LER at MPLS outlet removes the label from the packet and forwards the packet through the corresponding protocol of the external network.

MPLS technology isolates label distribution mechanism from data stream, it can be implemented independently to specific data link layer protocols, thus MPLS can support diverse physical layer and data link layer technologies. Presently, MPLS over FR (frame relay), MPLS over ATM (Asychronous Transfer Mode), MPLS over PPP (Point-to-Point) links, and MPLS over IEEE (Institute of Electrical and Electronics Engineers) 802.3 LANs has been achieved. Utilizing MPLS-based network to forward IP services simplifies inter-layer routing & forwarding process, thus accelerates MPLS switching, and enhances network efficiency; in addition, MPLS can transmit different levels of services; it combines high speed and flow control capability of switch and flexible functionality and QoS of router.

PSN (Packet switched network) is the developing trend of telecom networks and is mainly designed to carry IP services. Since IP services haven't brought satisfactory ROI to network operators and PSN has to be compatible to numerous non-IP network devices, communication networks with other switching modes have to be reserved in PSN environment. PWE3 (Pseudo Wire Emulation Edge-to-Edge) from IETF introduces a mechanism that provides conventional L1 and L2 network services on PSN. The aim of PWE3 is to form an integrated multi-service network platform. Herein, PSN includes IP (IPv4 and IPv6) network and MPLS network described above; the emulated L1 or L2 network services can be digital TDM (Time Division Multiplexing), FR, ATM, Ethernet, HDLC (High-Level Data Link Control), or PPP network services.

FIG. 2(a) shows network structure of PWE3 over PSN. The two PEs (Provider Edge) nodes 202 and 203 at the edge of PSN 201 provide one or multiple of PWs (Pseudo Wires) for CE (Customer Edge) nodes 204 and 205 connected to them, respectively, so that CEs can communicate with each other over PSN 201.

Herein, PWs support the communicating parties to establish conventional communication mechanisms, e.g., PPP; but the network implementation is transparent. PWs are implemented on the basis of tunnel mechanism over PSN. Native data units (e.g., bit, cell, packet) in PWES (PW End Service) are encapsulated into PW-PDUs (PW Protocol Data Units) first and then transmitted across the under-layer network through PSN tunnels. PEs accomplish necessary encapsulation and decapsulation for PW-PDUs and other functions required for PW services, such as sorting, timing, etc.; wherein, PW services are conventional communication services emulated by PWE3. Multicast services can be accomplished through duplicating packet payload to multiple PPP PWs or with inherent point-to-multi-point PWs; however, such approach requires multicast mechanism of under-layer PSN as well as point-to-multi-point PSN tunnels. PE receives native data units from CE (including payload and signaling) and executes some operations such as PREP (pre-processing) before sending the native data units to PW. PREP includes forwarding (FWD) and NSP (native service processing). PW multiplexing between two PEs can be implemented on a PSN tunnel through PW's maintenance mechanism and signaling support mechanism.

PW provides emulated physical or virtual connection so that CE can reach its remote counterpart. The sending PE encapsulates native data units from CE and transmits them to the receiving PE through PSN; the receiving PE decapsulates the native data units and recovers the payload to its original format, and then sends the payload to destination CE.

The protocol structure implemented by PWE3 architecture is shown in FIG. 2(b). The payload is transmitted on encapsulating layer, which contains information that doesn't exist in payload but is required by the opposite PE for sending data to CE via the physical interface; if any information beyond payload is unnecessary, the encapsulating layer may be omitted. PW multiplexing layer provides the capability of transmitting multiple PWs in the same PSN tunnel; PSN tunnels are identified on PSN layer, and specific PW in each tunnel should be identified as a unique one. The role of PSN converging layer is to enhance PSN interface and ensure consistency of interfaces between PSN and PWs, or make PWs independent to PSN type; if PSN meets service requirements, the PSN converging layer may be omitted.

When PWE3 architecture is implemented over MPLS network, MPLS external labels provide PSN tunnel function; while MPLS internal labels provide PW multiplexing function. Tunnel Labels and PW labels constitute a label stack on the concept of MPLS label stack. Since MPLS permits label pop-up at the last but one hop of LSP in the direction to destination, PWE3 is unable to see external labels at edge PEs of MPLS. Through application of internal/external labels, an edge PE can receive at least a label in any case and thereby obtain information enough to execute output operation. A tunnel is the path through which a PE transmits data to the opposite PE across MPLS network; multiple PWs can be multiplexed in a single tunnel.

RPR (Resilient Packet Ring) is a new MAC (Media Access Control) protocol introduced to optimize data packet transmission and is standardized by IEEE 802.17 workgroup.

FIG. 3(a) shows the network structure of RPR. A RPR network is a data optimized network and comprises at least tWo optical fiber sub-rings in reverse direction to each other; the nodes in the RPR shares bandwidth and don't need circuit assignation. With fair control algorithm, nodes in RPR can coordinate bandwidth automatically. Each node has a ring network topological diagram and can transmit data to the sub-rings and then to the destination nodes. Both of the sub-rings serve as working channels. To avoid link interruption due to optical fiber or node failures, a protective algorithm is used to eliminate corresponding failure segments. The nodes can utilize unicast destination address to transmit the packets to a specified node or utilize multicast destination addresses to transmit the packets to several points. RPR supports 3 service classes with different priorities.

FIG. 3(b) shows MAC protocol structure of RPR. Herein, MAC data function is designed to send and receive data packets; MAC control function is designed to transmit working state of the ring network; MAC bridging function provide L2 relaying services (i.e., restricted/unrestricted MAC services) for native nodes in the ring network. MAC control function comprises the following sub-units: fair control unit, designed to enable nodes in the ring network to share fair allowable bandwidth; protection control unit, designed to maintain state machine and database through communication with other nodes in the ring network so as to provide protection against node failures and cross-segment failures; topology control unit, designed to maintain topological data and state machine and exchange the information with other nodes in the ring network; OAM (Operation Administration Maintenance) control unit, designed to provide configuration function and failure state function. The MAC protocol of RPR includes the following mechanisms for packet processing: once a packet is sent to RPR, it will be transmitted to the destination node to avoid loss; packets arrive at the receiving node in the same order as they are sent, and therefore packet resorting at the receiving node is unnecessary; network nodes transmit packets transparently without packet duplication.

RPR can operate on different physical layer media, such as SONET (Synchronous Optical Network) and Ethernet.

To be different from conventional data link layer, RPR has higher bandwidth efficiency, supports for different services, easy-to-manage, resilience, and expandability. RPR has a wide application prospect.

At present, the data link layer of MPLS network is usually HDLC/PPP or Ethernet. When HDLC/PPP is used as the data link layer of MPLS network, point-to-point connections are usually established via POS interfaces; when Ethernet is used as the data link layer, L1 chain switching network, L2 tree switching network, or L3 meshed switching network are established via LAN interfaces (10/100M) or KM Ethernet (10GE) interfaces.

Therefore, PWE3 over MPLS PSN is implemented on the basis of HDLC/PPP or Ethernet data link layer at present.

In practice, above solution has the following disadvantages: since the protective capability of MPLS is not strong enough and the bandwidth utilization ratio is not high, the PWE3 architecture over it is low in efficiency and QoS.

The main cause for above disadvantages lies in that MPLS employs conventional data link layer protocols, which can't meet demands of future networks.

### SUMMARY OF THE INVENTION

The technical solution according to the present invention is to provide a method of implementing PWE3 (Pseudo Wire Emulation Edge-to-Edge) protocol, so as to implement PWE3 architecture over RPR-based MPLS PSN, provide protection and fair bandwidth sharing capability, and improve PWE3 quality and efficiency.

To solve above problems, the method of implementing PWE3 protocol according to the present invention comprises the following steps:

A. Encapsulating said PWE3 PSN layer data frame into RPR data frame;

B. Transmitting said RPR data frame to the destination node through RPR;

C. Decapsulating said RPR data frame into said PSN layer data frame at the destination node.

Wherein, said PWE3 PSN layer employs MPLS protocol.

Said PWE3 data link layer is said RPR.

Said step A further comprises the following sub-step:

Taking said PSN layer data frame as service data units of said basic RPR data frame directly.

Said step A further comprises the following sub-step:

Determining whether the length of said PSN layer data frame is shorter than or equal to maximum payload length of said RPR data frame; if so, taking said PSN layer data frame as payload directly and encapsulates them into said RPR data frame; otherwise discarding said PSN layer data frame.

Said step A further comprises the following sub-step:

Determining whether said PSN layer data frame is a unicast data frame or a multicast data frame; if it is a unicast data frame, setting ‘protocolType’ field of said RPR data frame as Hex 0x8847; if it is a multicast data frame, setting ‘protocolType’ field of said RPR data frame as Hex 0x8848.

Said step A further comprises the following sub-step:

Mapping ‘Experimental Use’ sub-field in ‘Tunnel Label’ field of said PSN layer data frame to ‘service class’ sub-field in ‘BaseControl’ field of said RPR data frame directly according to service priority sequence.

Said step A further comprises the following sub-step:

Determining the ‘service class’ sub-field in ‘BaseControl’ field of said RPR data frame according to combined influence of service class, service priority and labels of said PSN layer data frame.

Said step C comprises the following sub-step:

Removing the header of said RPR data frame and retrieving the payload from said RPR data frame as said PSN layer data frame.

By comparison with the prior art, the present invention has the following advantages: RPR is used as the data link layer in MPLS-based PWE3 architecture, so it encapsulates and carries MPLS data frame, and MPLS-based PWE3 transmission over RPR network is achieved.

The technical solution brings obvious benefits, i.e., it combines RPR and MPLS advantages into PWE3, enhances network bandwidth availability, achieves better support for GoS and QoS, and simplifies network management; it delivers automatic topology function, which improves network transmission reliability, network service resilience and network expandability.

### BRIEF DESCRIPTION OF THE DRAWINGS

FIG. 1 is a schematic diagram of MPLS network structure;

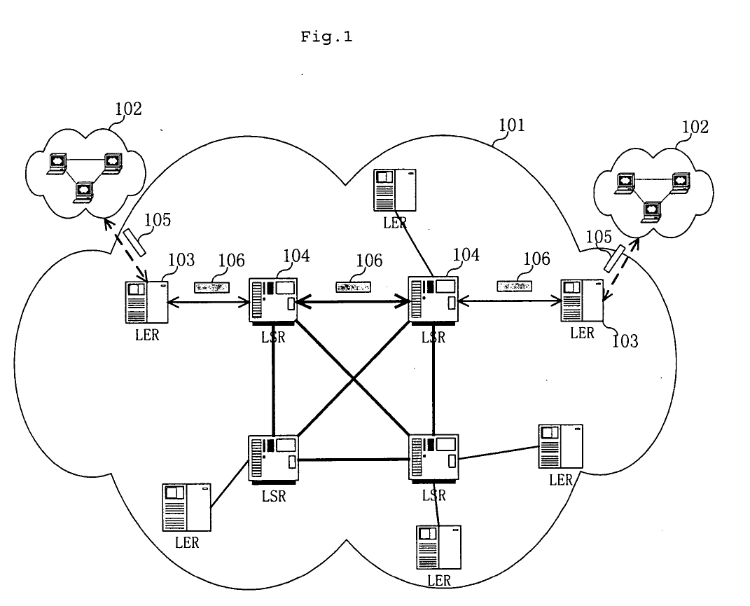

FIG. 2 is schematic diagrams of PWE3 network structure and protocol structure;

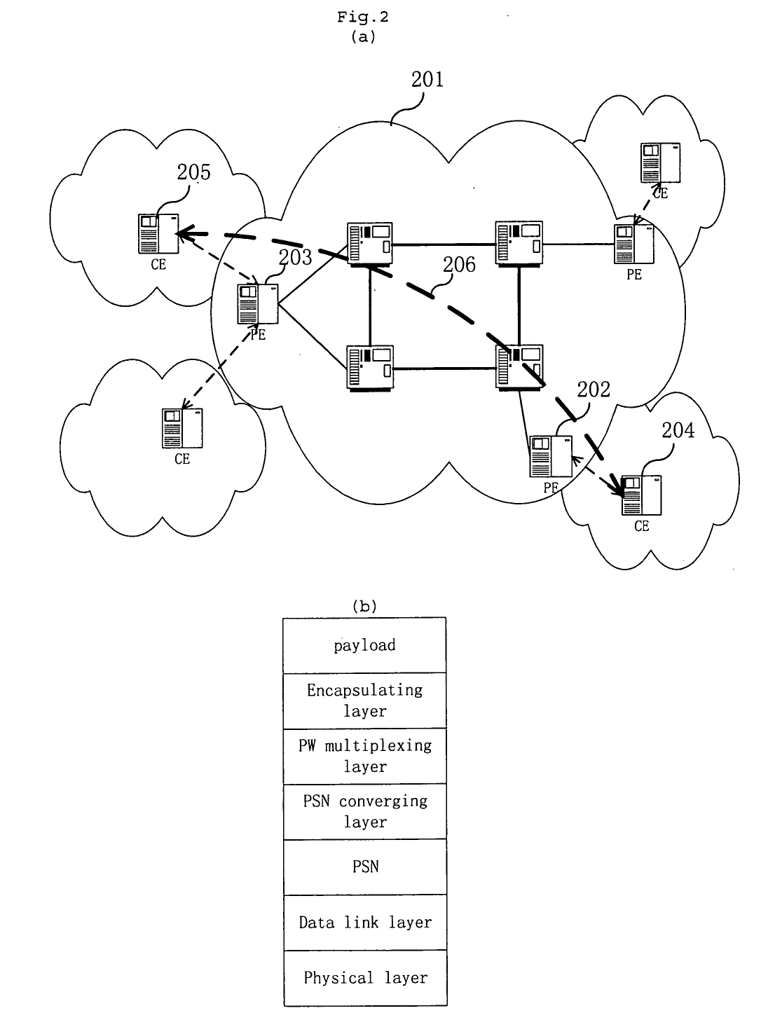

FIG. 3 is a schematic diagrams of RPR network structure and protocol structure;

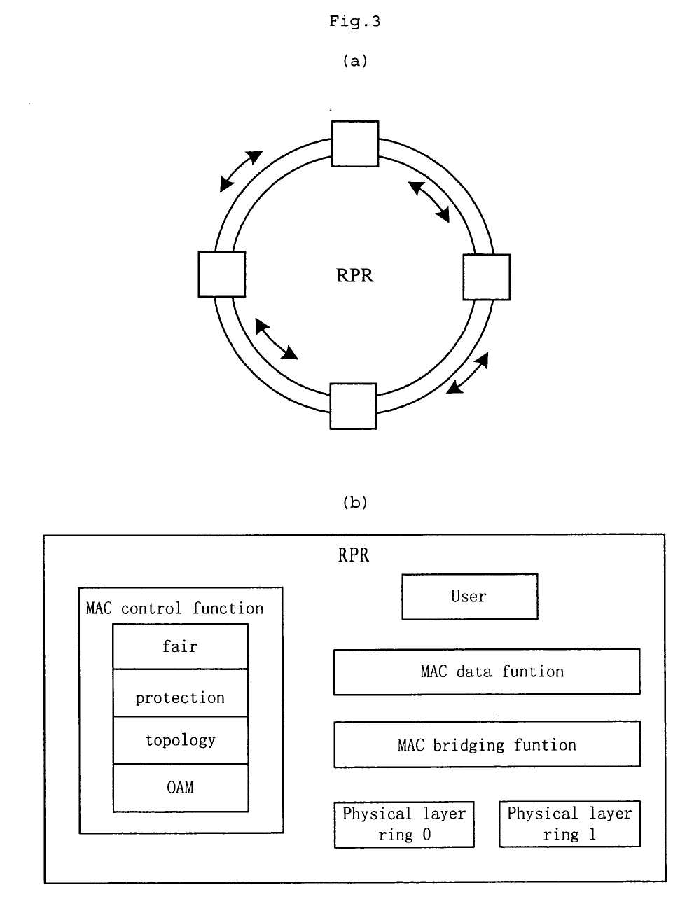

FIG. 4 shows RPR data frame encapsulation format for MPLS data packets in PWE3 architecture in an embodiment of the present invention.

### DETAILED DESCRIPTION OF THE EMBODIMENTS

In order to make the object, technical solution and advantages of the present invention more clearly, the present invention will be described in further detail with reference to the attached drawings.

According the present invention, RPR data frame is used to carry MPLS data, so MPLS PSN-based PWE3 architecture is achieved, which combines MPLS and RPR benefits in. It employs MPLS on PSN layer of PWE3 and employs RPR as data link layer of PWE3. The key to the present invention is how to encapsulate MPLS packets of PWE3 in RPR data frame.

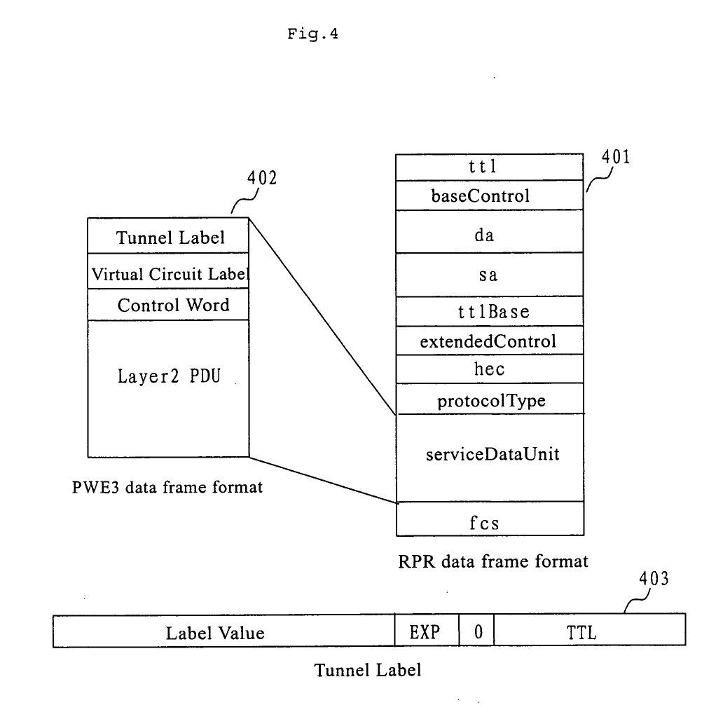

FIG. 4 shows RPR data frame encapsulation format for MPLS data packets in PWE3 architecture in an embodiment of the present invention.

The RPR data frame format 401 comprises the following data fields in sending sequence: 8-bit ttl (time to live), designed to indicate the maximum forwarding times of the data frame in RPR network to avoid network resource waste due to endless cycled transmission of the data frame in RPR ring; 8-bit BaseControl, designed to instruct and control data frame transmission, containing multiple of sub-fields; 48-bit da (destination address), designed to indicate MAC address of the destination node to which the frame is sent; 48-bit sa (source address), designed to indicate MAC address of the source node from which the frame is sent, herein MAC address is defined in IEEE802); 8-bit ttlBase, designed to set initial value of ttl of data frame transmission; 8-bit extendedControl, designed to extend BaseControl functions; 8-bit hec (header error checksum), designed to verify header data, herein said header comprises said fields of ttl, BaseControl, da, sa, ttlBase and extendedcontrol; 16-bit protocolType, which is the load part of the data frame and indicates length of current data frame if its value is less than 0x600, otherwise it indicates type of upper layer protocol above MAC layer; serviceDataUnit, variable in length, is user data unit above MAC layer; 32-bit fcs (frame check sequence), designed for CRC (cyclic redundancy check) for the frame, herein the calculating range of CRC covers the data after said ‘hec’ field to frame end (i.e., the payload of the frame) and includes two parts: protocolType and serviceDataUnit.

Said ‘BaseControl’ field comprises several sub-fields related with RPR control, including 2-bit sc (service class), designed to indicate service class of the RPR data frame; different service classes correspond to different QoS and priorities.

It is noted that above RPR data frame format 401 is the basic data frame format. Extended RPR data frame format also comprises: 48-bit daExtended designed to extend function of the da; 48-bit saExtended designed to extend function of the sa.

The upper layer above RPR MAC layer is MPLS-based PWE3 architecture. As shown in FIG. 4, in an embodiment of the present invention, the serviceDataUnit in said RPR data frame is MPLS data frame of PWE3. Therefore, PWE3 service data packets are encapsulated in RPR data frame.

Herein, the MPLS data frame format 402 of PWE3 (i.e., the ‘serviceDataUnit’ field of RPR data frame format 401) comprises the following data fields in sending sequence: 32-bit Tunnel Label 403, i.e., MPLS label; 32-bit VC Label (Virtual Circuit Label), i.e., internal label of MPLS label stack, designed for PW multiplexing in a tunnel; Control Word, designed to execute MPLS control functions; Layer2 PDU, variable in length, i.e., PDU of L2 service emulated by PWE3. Wherein said Tunnel Label 403 related with MPLS comprises the following sub-fields: the first 20-bit Label Value, which is designed to identify the tunnel for transmission; the next 3-bit EXP (Experimental Use), which is reserved for experiment, but in some applications, it is used to indicate service priority of said MPLS frame; the next 1-bit Bottom of Stack sign, wherein ‘1’ indicates bottom of stack, ‘0’ indicates others (herein is ‘0’); the next 8-bit TTL (Time to Live) indicates the maximum number of forwarding times of the frame, in order to avoid unlimited forwarding.

The method of implementing PWE3 MPLS data packet transmission over RPR comprises the following steps:

Step 1: Encapsulating MPLS data frame into RPR data frame;

Step 2: Transmitting RPR data frame to the destination node through RPR;

Step 3: Decapsulating RPR data frame into PSN layer data frame at the destination node. Said PSN layer data frame is the MPLS data frame. The decapsulation process is the reverse one of above encapsulation process and is designed to remove RPR frame header and retrieve the payload. It should be noted that only two link layer technologies bearing MPLS are defined in the prior art: Ethernet MAC and PPP protocol. Now RPR is added as another option.

Wherein step 1 (encapsulation) further comprises the following sub-steps:

First, as described above, encapsulate PSN layer of PWE3 (i.e., MPLS data frame) into the RPR frame as payload. If the MPLS data frame is longer than the permissible limit of RPR data frame, discard the MPLS data frame directly. Usually above case happens under either of the following two conditions: the processing capacity of under-layer device isn't enough to carry the MPLS data frame; and a huge packet occurs (and ought to be discarded) due to failure of upper layer. So overlong data packets are transmitted by segment from client side automatically in actual cases, the mechanism of transmission by segment is not taken into consideration in RPR data link layer and PSN layer.

In addition, to mark the type of upper layer protocol that transmits the RPR data frame, the ‘protocolType’ field of RPR frame is used to indicate MPLS data frame. With reference to RFC 3032, in an embodiment of the present invention, RPR protocolType 0x8847 indicates MPLS unicast data frame; RPR protocolType 0x8848 indicates MPLS multicast data frame.

In another embodiment of present invention, when ‘EXP’ field in ‘Tunnel Label’ is used to indicate service priority, the system will map said priority information into ‘service class’ sub-field of ‘BaseControl’ field in RPR data frame according to a rule designated by the system designer (e.g., mapping according to priority sequence). In another embodiment of present invention, the information is mapped to RPR Service priority with comprehensive consideration of various affecting factors in PSN (service type, priority, label, etc.) and then recorded into ‘service class’ sub-field of ‘BaseControl’ field in the RPR data frame. In that way, the service type of upper layer protocol is reflected on the lower layer, so that network transmission on each layer is carried out strictly according to GoS, and thereby QoS is improved.

With the method of carrying PWE3 MPLS data packets with RPR data frame, PWE3 is enabled in MPLS networks that employ RPR as the data link layer; implementations on the layers may be standard ones; for instance, transmission of RPR data frame and encapsulation & transmission of other frame may be implemented according to IEEE 802.17; MPLS data packet transmission control and PWE3 operation may be implemented according to IETF standard.

Those skilled in the art should understand that the sub-steps of above step 1 (encapsulation) can be combined freely without departing from the spirit and scope of the present invention.

Though the present invention is shown and described with reference to some preferred embodiments, those skilled in the art should understand that various modifications to the present invention can be made without departing from the spirit and scope of the present invention.

1. A method of implementing PWE3 (Pseudo Wire Emulation Edge-to-Edge) protocol, comprising the steps of:
A. Encapsulating said PWE3 PSN (Packet Switched Network) layer data frame into RPR (Resilient Packet Ring) data frame;
B. Transmitting said RPR data frame to the destination node through RPR;
C. Decapsulating said RPR data frame into said PSN layer data frame at the destination node.

2. A method of implementing PWE3 protocol according to claim 1, wherein said PWE3 PSN layer employs MPLS protocol.

3. A method of implementing PWE3 protocol according to claim 2, wherein said PWE3 data link layer is said RPR.

4. A method of implementing PWE3 protocol according to claim 3, wherein said step A further comprises the following sub-step:
taking said PSN layer data frame as serviceDataUnit of said basic RPR data frame directly.

5. A method of implementing PWE3 protocol according to claim 4, wherein said step A further comprises the following sub-step:
Determining whether the length of said PSN layer data frame is shorter than or equal to maximum payload length of said RPR data frame; if so, taking said PSN layer data frame as payload directly and encapsulates them into said RPR data frame; otherwise discarding said PSN layer data frame.

6. A method of implementing PWE3 protocol according to claim 4, wherein said step A further comprises the following sub-step:
Determining whether said PSN layer data frame is a unicast data frame or a multicast data frame; if it is a unicast data frame, setting ‘protocolType’ field of said RPR data frame as Hex 0x8847; if it is a multicast data frame, setting ‘protocolType’ field of said RPR data frame as Hex 0x8848.

7. A method of implementing PWE3 protocol according to claim 4, wherein said step A further comprises the following sub-step:
Mapping ‘Experimental Use’ sub-field in ‘Tunnel Label’ field of said PSN layer data frame to ‘service class’ sub-field in ‘BaseControl’ field of said RPR data frame directly according to service priority sequence.

8. A method of implementing PWE3 protocol according to claim 4, wherein said step A further comprises the following sub-step:
Determining the ‘service class’ sub-field in ‘BaseControl’ field of said RPR data frame according to combined influence of service class, service priority and labels of said PSN layer data frame.

9. A method of implementing PWE3 protocol according to claim 1, wherein said step C comprises the following sub-step:
removing the header of said RPR data frame and retrieving the payload of said RPR data frame as said PSN layer data frame.
